(19) United States
(12) Patent Application Publication
(10) Pub. No.: US 2017/0295194 A1
(43) Pub. Date: Oct. 12, 2017

(54) EVALUATING THE EVALUATION BEHAVIORS OF EVALUATORS

(71) Applicant: Microsoft Technology Licensing, LLC, Redmond, WA (US)

(72) Inventors: Imed Zitouni, Bellevue, WA (US); Ahmed Awadallah, Redmond, WA (US); Bradley Paul Wethington, Seattle, WA (US); Aidan C Crook, Los Altos, CA (US)

(21) Appl. No.: 15/218,968

(22) Filed: Jul. 25, 2016

Related U.S. Application Data
(60) Provisional application No. 62/320,373, filed on Apr. 8, 2016.

(51) Int. Cl. H04L 29/06

(52) U.S. Cl. CPC H04L 63/1425; H04L 63/1408

(57) ABSTRACT

Systems and methods for evaluating the evaluation behaviors of an evaluator are presented. In contrast to evaluation methods that monitor and analyze click behaviors, the disclosed subject matter is directed to evaluating non-click behaviors. After obtaining results of an evaluation request submitted to a response service for evaluation by the evaluator, evaluation behaviors of the evaluator are monitored. The monitored evaluation behaviors are in association with an evaluation of the obtained results and one or more heuristics or rules are applied to the monitored evaluation behaviors to determining whether the monitored evaluation behaviors are within predetermined quality thresholds. If the monitored evaluation behaviors are not within the predetermined quality thresholds, the monitored evaluation behaviors are flagged as anomalous evaluation behaviors.

### BACKGROUND

Companies spend millions of dollars each a year in providing response services, i.e., services that respond to user requests/queries. For example, in response to a user's query, “How tall is Mount Rainier?”, a response service would provide information indicating that Mount Rainier is 14,411 feet high. Of course, response services don't simply answer questions. Indeed, an online response service may receive a request such as, “Schedule a meeting with Amy,” and in response the response service might indicate one or more time slots in which a meeting could take place, or simply a confirmation that a meeting has been booked in the first available time slot with “Amy.”

Obviously, it is important that each response service generates accurate, desirable, and high quality results, irrespective of the form in which those results are manifested. To ensure that the results/responses of a response service are accurate, desirable, and of high quality, the companies that provide the response services typically hire human evaluators to evaluate the responses to simulated/sample requests. Simply put, the task for these evaluators is to evaluate the results of sample requests to determine the quality and/or effectiveness of the results.

Generally speaking, the evaluations of the evaluators are used to refine the results of an online response service to various requests. If the evaluators determine that the results of the response service to a sample request is accurate and of high quality, then that feedback with be used to ensure that the response service will be more likely to respond to the same or similar request from users with those results. Alternatively, if the evaluators determine that the results are poor (i.e., inaccurate, undesirable, of poor quality, etc.), then that information is used by the response service to refine the internal operations such that it will be less likely to provide that same set of results to users for the same (or similar) request.

While evaluators valuate the quality of generated responses to various user requests, the question arises, “How does an organization determine whether the evaluators are conducting quality evaluations?” One means that was often employed was to monitor the clicks of the evaluator with regard to a set of results. Yet another means was to interject requests in which the set of results was known to be good or bad, and then evaluate the evaluator's behavior based on similarity to the known results. However, while results used to be delivered as a series of result pages, each page comprising “10 blue links” to related content, more and more people are utilizing computing devices that do not lend themselves to mouse clicks. Indeed, hand held computing devices with minimal display resources and that utilize swipes, audio feedback, panning and zooming and the like are commonly used and results to a given request are tailored to those devices. With these devices, monitoring click patterns of an evaluator is largely inapplicable.

### SUMMARY

According to aspects of the disclosed subject matter, systems and methods for evaluating the evaluation behaviors of an evaluator are presented. In contrast to evaluation methods that monitor and analyze click behaviors, the disclosed subject matter is directed to evaluating non-click behaviors. After obtaining results of an evaluation request submitted to a response service for evaluation by the evaluator, evaluation behaviors of the evaluator are monitored. The monitored evaluation behaviors are in association with an evaluation of the obtained results and one or more heuristics or rules are applied to the monitored evaluation behaviors to determining whether the monitored evaluation behaviors are within predetermined quality thresholds. If the monitored evaluation behaviors are not within the predetermined quality thresholds, the monitored evaluation behaviors are flagged as anomalous evaluation behaviors.

According to additional aspects of the disclosed subject matter, a computer-implemented method for evaluating the evaluation behaviors of an evaluator is presented. In execution, results of an evaluation request submitted to a response service for evaluation by the evaluator are obtained. The evaluation behaviors of the evaluator are monitored with regard to the obtained results, where the monitored evaluation behaviors include at least one or more non-click evaluation behaviors. The monitored evaluation behaviors are stored in association with an evaluation of the obtained results by the evaluator and one or more heuristics or rules are applied to the monitored evaluation behaviors to determining whether the monitored evaluation behaviors are within predetermined quality thresholds. The monitored evaluation behaviors are flagged as anomalous evaluation behaviors if the monitored evaluation behaviors are not within the predetermined quality thresholds.

According to still further aspects of the disclosed subject matter, a computer-readable medium bearing computer-executable instructions is presented. When executed on a computing device comprising at least a processor executing instructions retrieved from a memory, the instructions cause the computing device to carry out a method for evaluating the evaluation behaviors of an evaluator. The method includes the step of obtaining a plurality of results of a corresponding plurality of evaluation requests submitted to a response service for evaluation by the evaluator. Further, evaluation behaviors of the evaluator are monitored with regard to each of the plurality of obtained results, where the monitored evaluation behaviors include one or more non-click evaluation behaviors. Evaluation records corresponding to each of the plurality of evaluation requests are stored, where each evaluation record includes the monitored evaluation behaviors the evaluator with regard to the evaluation of obtained results corresponding to one of the plurality of evaluation requests and the evaluation of the evaluator with regard to the obtained results. Then, for each of the stored evaluation records, one or more heuristics or rules are applied to the monitored evaluation behaviors of the evaluation record to determining whether the monitored evaluation behaviors are within predetermined quality thresholds, and the evaluation record are flagged as anomalous if the corresponding monitored evaluation behaviors are not within the predetermined quality thresholds.

Addition to additional aspects of the disclosed subject matter, a computing system for evaluating the evaluation behaviors of an evaluator is presented. The computing system includes a processor and a memory, wherein the processor executes instructions stored in the memory as part of or in conjunction with additional executable components to evaluate the evaluation behaviors of an evaluator. These additional executable component include an evaluation request module and an evaluation module. The evaluation request module, in execution, causes the processor to submit an evaluation request to a response service and, in response, obtain results from the response service corresponding to the evaluation request. The evaluation module monitors the evaluation behaviors of the evaluator with regard to the obtained results, where the monitored evaluation behaviors include one or more non-click evaluation behaviors. Additionally, the evaluation module stores the monitored evaluation behaviors in association with an evaluation of the obtained results by the evaluator and applies one or more heuristics or rules to the monitored evaluation behaviors to determining whether the monitored evaluation behaviors are within predetermined quality thresholds. For those evaluation behaviors determined to be outside the predetermined quality thresholds, they are flagged as anomalous evaluation behaviors.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating a network environment suitable for implementing aspects of the disclosed subject matter;

FIG. 2 is a flow diagram illustrating an exemplary routine for generating evaluation information regarding an evaluator;

FIG. 3 is a flow diagram illustrating an exemplary routine for analyzing/evaluating an evaluator's evaluation behaviors to determine the quality of those behaviors, particularly whether the evaluation behaviors fall within acceptable ranges;

FIG. 4 is a block diagram illustrating an exemplary computer readable medium encoded with instructions to evaluate the evaluations of an evaluator; and

FIG. 5 is a block diagram illustrating an exemplary computing device configured to provide evaluation services of an evaluator.

### DETAILED DESCRIPTION

For purposes of clarity and definition, the term “exemplary,” as used in this document, should be interpreted as serving as an illustration or example of something, and it should not be interpreted as an ideal or a leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

The term “evaluator” refers to a human whose purpose is to make a judgement regarding one or more aspects of the results generated by the response service in response to a request. As suggested, the “results” generated in response to a request may be in the form of information (audio, visual, textual, files, etc.) provided to a requesting party (e.g., the evaluator in response to submitting an evaluation request), one or more actions taken on behalf of the requesting party, a combination of provision of information and/or data as well as one or more actions, and the like.

The term “evaluation request” refers to a request that is submitted by an evaluator to a response service, where the results of the evaluation request are to be evaluated by the evaluator. The term “control request” or “control evaluation request” refers to an evaluation request that is provided to the evaluator for submission to the response service in the course of evaluating the results. However, in contrast to a typical evaluation request, the quality of the results returned by the response service to a control request are predetermined and/or already known. Ideally, a control request is not identifiable to the evaluator as a control request. The purpose of the control request is to receive the evaluator's evaluation of the results for the requesting service and be able to compare that evaluation against the predetermined, known evaluation.

Generally speaking, an evaluator is supplied a set of evaluation requests with the purpose of submitting the evaluation requests to a request service, evaluating the results, and storing (or submitting to a retention/processing service) the evaluator's evaluation of the quality of the results in conjunction with the evaluation request. Additionally, and according to aspects of the disclosed subject matter, evaluation behaviors of the evaluator in evaluating the results are recorded in associating with the evaluator's evaluation. These evaluation behaviors, in conjunction with the associated evaluation, are then used to determine one or more qualitative aspects of the evaluator's evaluation behaviors. These qualitative aspects include accuracy rates, the nature of the evaluator's evaluative behaviors, efficiencies and biases with regard to results, and the like.

As mentioned above, simply monitoring clicks on various links is entirely inapplicable when a user's interaction (or an evaluator's interaction) with results is made on a device that does not utilize an input cursor. Indeed, on computing devices of limited display resource, such as mobile phones and/or tablet devices, directly presenting the desired information rather than presenting a set of hyperlinks to information is the norm. In these instances, determining which links an evaluator follows (though click monitoring) has little to no applicability. Thus, according to additional aspects of the disclosed subject matter, various evaluation behaviors of the evaluator are monitored and recorded, including one or more non-click evaluation behaviors. These non-click evaluation behaviors include by way of illustration and not limitation: the speed at which the evaluator makes an evaluation determination; the amount of time the evaluator takes to read a particular set of results; panning/scrolling displayed results; the speed of panning/scrolling displayed results; touch-based events, including inferred touch events based on the amount of time that items are visible on a display device; utilizing zoom features to expand data; swiping/dismissing results from the computing device screen and the speed of swiping/dismissing results from the computing device screen; the distance and direction of swipe gestures; and the like as well as combinations thereof. In those circumstances in which elements of the disclosed subject matter are applied to computing devices utilizing pointing devices (e.g., mouse, track pad, etc.), non-click evaluation behaviors may also include hovering time (e.g., the amount of time that a pointing device hovers over a location or item), speed of pointer movement, a pointer following textual lines, and the like. Of course, the evaluation behaviors may be analyzed in light of information regard the results, including the type of results that are provided; the expertise of the evaluator; the complexity of the results; time constraints on the evaluator; and the like. Thus, while aspects of the disclosed subject matter are well suited to evaluate an evaluator's non-click behaviors, the disclosed subject matter may be suitably applied to situations in which all of some pointer or mouse click behaviors are also utilized.

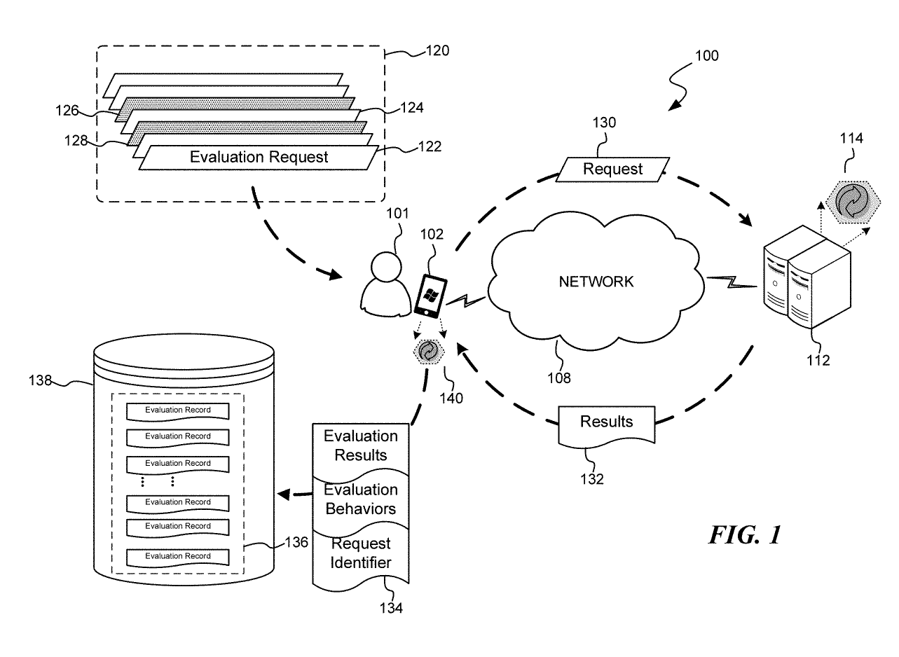

To better illustrate the various aspects of the disclosed subject matter, reference is made to the figures. Turning to FIG. 1, FIG. 1 is a pictorial diagram illustrating a network environment 100 suitable for implementing aspects of the disclosed subject matter. As shown in FIG. 1, an evaluator 101 operating on a computing device 102 receives a set 120 of evaluation requests for execution and evaluation of the results, such as evaluation requests 122-124. The set 120 of evaluation requests may also include various control requests, such as control requests 126-128, for use in determining the accuracy of the evaluator's evaluations.

With regard to the evaluation requests of the set 120, typically the evaluator 101 iteratively processes each evaluation request of the set, where processing includes, by way of illustration and not limitation, submitting an evaluation request 130 to a response service 114 that operates on another computing device 112, often over a network 108. In response to the evaluation request, the response service 112 provides results 132. Generally, the results 132 that are “returned” in response to an evaluation request 130 comprise data/information for presentation to requester/evaluator; an action taken on behalf of the requester/evaluator; or a combination of the two.

Processing continues for the evaluator in evaluating the results 132 and generating his/her evaluation of the results. A monitoring process 140 executing on the evaluator's computing device 102 records the evaluator's evaluation behaviors. Upon the evaluator entering his/her evaluation, the evaluation results, the evaluation behaviors and an evaluation request identifier (an identifier corresponding to the recently evaluated evaluation request) are stored as an evaluation record, such as evaluation record 134, among a set of evaluation records 136 in a data store 138. As will be discussed below, the information in the evaluation records is used to evaluate the evaluation behavior of an evaluator.

While the discussion in regard to FIG. 1 is made with the evaluator submitting the evaluation requests to the response service 114 over a network, this is illustrative and should not be viewed as limiting upon the disclosed subject matter. In an alternative embodiment, for efficiency purposes, the results may be pre-generated and available in conjunction with the evaluation requests such that a network request to the response service 114 is not necessary and/or may be simulated on the evaluator's computing device 102.

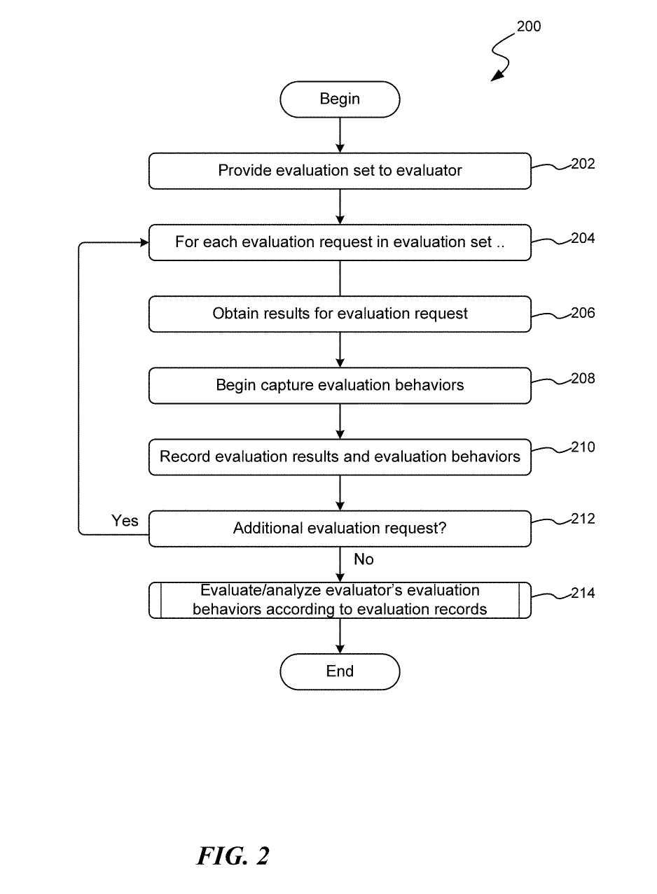

Turning to FIG. 2, FIG. 2 is a flow diagram illustrating an exemplary routine 200 for evaluating the behaviors of an evaluator. Beginning at block 202, an evaluator is provided with a set of evaluation requests for evaluation by the evaluator. At block 204, an iteration loop is begun in which the evaluation iteratively processes at least some of the evaluation requests of the set of evaluation requests. The evaluation iteration includes the following.

At block 206, the results of the currently iterated evaluation request are obtained. At 208, the evaluation behaviors of the evaluator are captured with regard to the results of the evaluation request. At block 210, the evaluator's evaluation of the results for the currently iterated evaluation request is recorded in an evaluation record, along with the evaluation behaviors of the evaluator. At block 212, if there are additional evaluation requests to process in the set of evaluation requests, the process returns to block 204 where the next evaluation request of the set of evaluation requests is selected for processing. Alternatively, if there are no additional evaluation requests to process, the routine 200 proceeds to block 214.

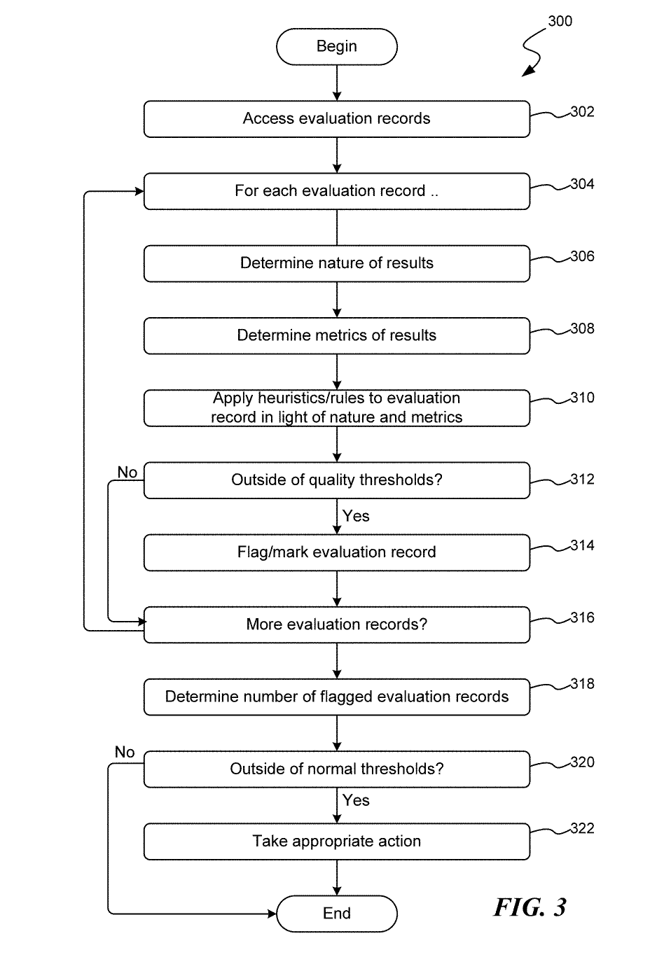

At block 214, the evaluator's evaluation behaviors are analyzed to determine the quality of those behaviors. This evaluation/analysis is described below in regard to FIG. 3. Turning, then, to FIG. 3, FIG. 3 is a flow diagram illustrating an exemplary routine 300 for analyzing/evaluating an evaluator's evaluation behaviors to determine the quality of those behaviors, particularly whether the evaluation behaviors fall within acceptable ranges. Beginning at block 302, the evaluation records of the evaluator are accessed.

At block 304, an iteration loop is begun to iterate through each of the evaluation records of the evaluator. At block 306, the nature of the results of the currently iterated evaluation record is determined. By way of example and not limitation, the nature of the results may be an action taken on behalf of the computer user 101. Alternatively, the nature of the results may be information that satisfies the request. Still alternatively, the nature of the results may include both actions and information.

At block 308, metrics corresponding to the particular results, as determined according to the nature of the results, is determined. By way of illustration and not limitation, the metrics may include the display size needed to present the results, a particular action taken on behalf of the computer user 101, whether the result content could be expanded or explored, and the like in order to identify the types of evaluator interactions that are available.

At block 310, heuristics and/or rules are applied to the evaluation behaviors recorded in or with the currently iterated evaluation record in light of the results nature and metrics. These rules may include determining the rate of scroll of content on a display device, the speed at which the results are dismissed, whether content was expanded through user (evaluator) interaction, whether user interaction evaluated the results of an action take in response to the request, the correctness of the evaluator's evaluation, and the like.

The applied heuristics and/or rules generate a relative value that can be compared against predetermined quality thresholds to determine whether this particular evaluation falls outside of the quality thresholds. Thus, at block 312, if the generated value is outside of the predetermined quality thresholds, the routine 300 proceeds to block 314 where the evaluation record is flagged (or marked) as anomalous, i.e., falling outside of the predetermined quality thresholds. Alternatively, if the generated value is within the predetermined quality thresholds, the routine 300 proceeds to block 316. At block 316, if there are additional evaluation records to be processed, the routine 300 returns to block 304 to process the next evaluation record. Alternatively, the routine 300 proceeds to block 318.

At block 318, a determination as to the number (or percentage or scores) of the evaluation records that have been flagged are determined. At block 320, if the determined number/percentage/score falls outside of predetermined normal thresholds, the routine proceeds to block 322 where appropriate action is taken. Appropriate action may include, by way of illustration and not limitation, sending a notice to a supervisor to review and/or take action, providing an indication to the evaluator that his/her evaluation behaviors are outside of normal thresholds, and the like. Thereafter, or if the determined number/percentage/score falls inside of the predetermined normal thresholds, the routine 300 terminates.

Returning again to FIG. 2, after analyzing the evaluator's evaluation behaviors to determine the quality of those behaviors, and taking action as set forth in FIG. 3, the routine 200 terminates.

Regarding routines 200 and 300 described above, as well as other processes describe herein, while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines/processes are typically embodied within executable code modules comprising routines, functions, looping structures, selectors and switches such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processors via various transmission means and mediums, including carrier waves and/or propagated signals, for purposes of this disclosure computer readable media expressly excludes carrier waves and/or propagated signals.

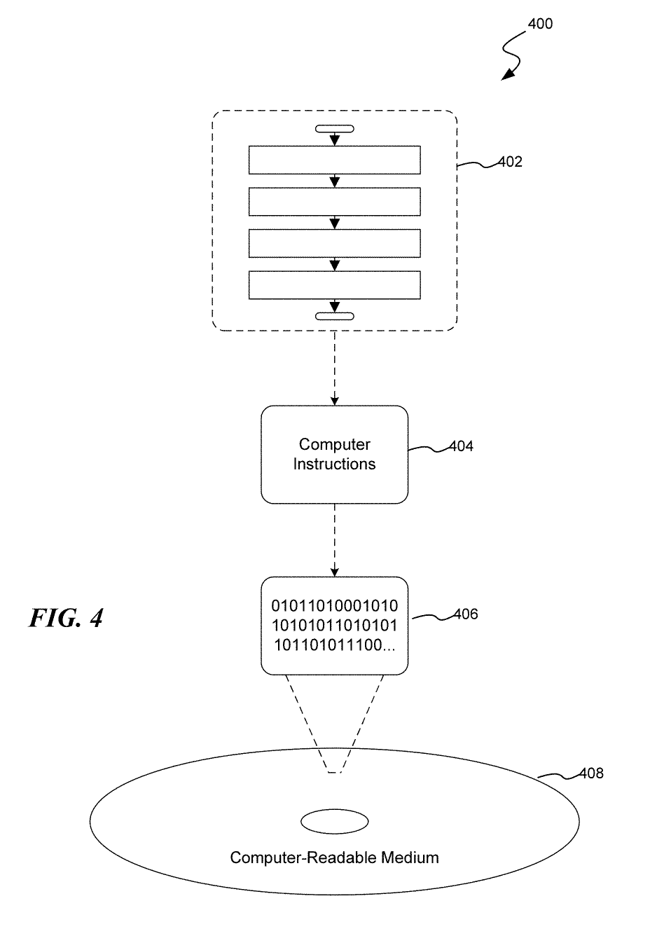

Turning to FIG. 4, FIG. 4 is a block diagram illustrating an exemplary computer readable medium encoded with instructions to generate metadata in regard to an image, respond to an image request with the image and metadata, and/or request an image from an online image service as described above. More particularly, the implementation 400 comprises a computer-readable medium 408 (e.g., a CD-R, DVD-R or a platter of a hard disk drive), on which is encoded computer-readable data 406. This computer-readable data 406 in turn comprises a set of computer instructions 404 configured to operate according to one or more of the principles set forth herein. In one such embodiment 402, the processor-executable instructions 404 may be configured to perform a method, such as exemplary methods/routines 200 and 300, for example. In another such embodiment, the processor-executable instructions 404 may be configured to implement a system, such as exemplary system 500 as described below. Many such computer-readable media may be devised, by those of ordinary skill in the art, which are configured to operate in accordance with the techniques presented herein.

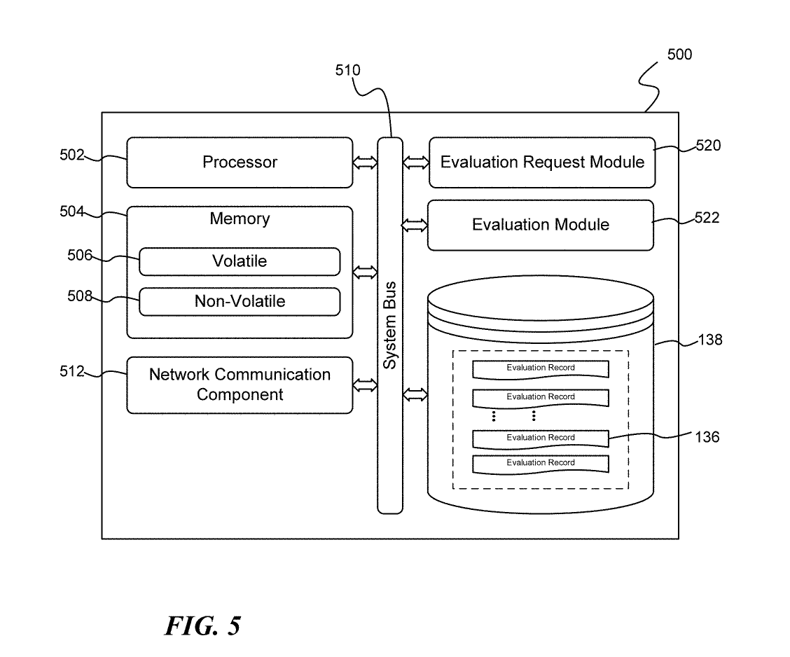

Turning now to FIG. 5, FIG. 5 is a block diagram illustrating an exemplary computing device 500 configured to provide evaluation services of an evaluator, as described above. The exemplary computing device 500 includes one or more processors (or processing units), such as processor 502, and a memory 504. The processor 502 and memory 504, as well as other components, are interconnected by way of a system bus 510. The memory 504 typically (but not always) comprises both volatile memory 506 and non-volatile memory 508. Volatile memory 506 retains or stores information so long as the memory is supplied with power. In contrast, non-volatile memory 508 is capable of storing (or persisting) information even when a power supply is not available. Generally speaking, RAM and CPU cache memory are examples of volatile memory 506 whereas ROM, solid-state memory devices, memory storage devices, and/or memory cards are examples of non-volatile memory 508.

As will be appreciated by those skilled in the art, the processor 502 executes instructions retrieved from the memory 504 (and/or from computer-readable media, such as computer-readable media 400 of FIG. 4) in carrying out the evaluation of an evaluator, as set forth above. The processor 502 may be comprised of any of a number of available processors such as single-processor, multi-processor, single-core units, and multi-core units.

Further still, the illustrated computing device 500 includes a network communication component 512 for interconnecting this computing device with other devices and/or services over a computer network, including other user devices, such as user computing devices 102 of FIG. 1. The network communication component 512, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 512, is typically comprised of hardware and/or firmware components (and may also include or comprise executable software components) that transmit and receive digital and/or analog signals over a transmission medium (i.e., the network.)

Also included in the exemplary computing device 500 is an evaluation request module 520. The evaluation request module generates and/or accesses evaluation requests and provides the sets of evaluation requests to one or more evaluators. A data store 138 stores evaluation records as described above.

Also included is an evaluation module 522. The evaluation module 522 conducts the analysis of the evaluator's evaluation behaviors, according to the stored evaluation records, e.g., evaluation record 136, in the data store 138, to determine whether the evaluative behaviors fall outside of a norm, and whether or not additional action should be taken.

Regarding the various components of the exemplary computing device 500, those skilled in the art will appreciate that many of these components may be implemented as executable software modules stored in the memory of the computing device, as hardware modules and/or components (including SoCs—system on a chip), or a combination of the two. Indeed, components may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

Moreover, in certain embodiments each of the various components of the exemplary computing device 500 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network, such as network 108 of FIG. 1.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for evaluating the evaluation behaviors of an evaluator, the method comprising:
obtaining results of an evaluation request submitted to a response service for evaluation by the evaluator;
monitoring evaluation behaviors of the evaluator on a computing device with regard to the obtained results, wherein the monitored evaluation behaviors include one or more non-click evaluation behaviors;
storing the monitored evaluation behaviors in association with an evaluation of the obtained results by the evaluator;
applying one or more heuristics or rules to the monitored evaluation behaviors to determining whether the monitored evaluation behaviors are within predetermined quality thresholds; and
flagging the monitored evaluation behaviors as anomalous evaluation behaviors if the monitored evaluation behaviors are not within the predetermined quality thresholds.

2. The computer-implemented method of claim 1, wherein the monitored evaluation behaviors consist of non-click evaluation behaviors.

3. The computer-implemented method of claim 2, wherein the monitored evaluation behaviors include one or more of panning displayed results on the computing device and the speed of panning displayed results on the computing device.

4. The computer-implemented method of claim 2, wherein the monitored evaluation behaviors include utilizing zoom features of the computing device to expand data of the displayed results.

5. The computer-implemented method of claim 2, wherein the monitored evaluation behaviors include swiping results from the screen and the speed of panning displayed results on the computing device.

6. The computer-implemented method of claim 1 further comprising:
obtaining a plurality of results of a corresponding plurality of evaluation requests submitted to a response service for evaluation by the evaluator;
monitoring evaluation behaviors of the evaluator on a computing device with regard to each of the plurality of obtained results, wherein the monitored evaluation behaviors include one or more non-click evaluation behaviors;
storing a plurality of evaluation records, each of the plurality of evaluation records comprising obtained results of the plurality of obtained results, an evaluation of the evaluator with regard to the obtained results, and corresponding monitored evaluation behaviors of the evaluator; and
for each of the plurality of evaluation records:
applying one or more heuristics or rules to the corresponding monitored evaluation behaviors to determining whether the corresponding monitored evaluation behaviors are within predetermined quality thresholds; and
flagging the evaluation record as anomalous if the corresponding monitored evaluation behaviors are not within the predetermined quality thresholds.

7. The computer-implemented method of claim 6 further comprising:
determining whether the number of evaluation records flagged as anomalous exceed predetermined thresholds; and
executing an action with regard to the evaluator if the number of evaluation records flagged as anomalous exceeds the predetermined thresholds.

8. The computer-implemented method of claim 7, wherein the monitored evaluation behaviors consist of non-click evaluation behaviors.

9. The computer-implemented method of claim 7, wherein the monitored evaluation behaviors include one or more of panning displayed results on the computing device and the speed of panning displayed results on the computing device.

10. The computer-implemented method of claim 7, wherein the monitored evaluation behaviors include utilizing zoom features of the computing device to expand data of the displayed results.

11. The computer-implemented method of claim 7, wherein the monitored evaluation behaviors include swiping results from the screen and the speed of panning displayed results on the computing device.

12. A computer-readable medium bearing computer-executable instructions which, when executed on a computing device comprising at least a processor executing instructions retrieved from a memory, carry out a method for evaluating the evaluation behaviors of an evaluator, the method comprising:
obtaining a plurality of results of a corresponding plurality of evaluation requests submitted to a response service for evaluation by the evaluator;
monitoring evaluation behaviors of the evaluator with regard to each of the plurality of obtained results, wherein the monitored evaluation behaviors include one or more non-click evaluation behaviors;
storing evaluation records corresponding to each of the plurality of evaluation requests, each evaluation record comprising the monitored evaluation behaviors the evaluator with regard to the evaluation of obtained results corresponding to one of the plurality of evaluation requests and the evaluation of the evaluator with regard to the obtained results;
for each of the stored evaluation records:
applying one or more heuristics or rules to the monitored evaluation behaviors of the evaluation record to determining whether the monitored evaluation behaviors are within predetermined quality thresholds; and
flagging the evaluation record as anomalous if the monitored evaluation behaviors are not within the predetermined quality thresholds.

13. The computer-readable medium of claim 12, wherein the monitored evaluation behaviors consist of non-click evaluation behaviors.

14. The computer-readable medium of claim 12, wherein the method further comprises:
determining whether the number of evaluation records flagged as anomalous exceed predetermined thresholds; and
executing an action with regard to the evaluator if the number of evaluation records flagged as anomalous exceeds the predetermined thresholds.

15. The computer-readable medium of claim 12, wherein the monitored evaluation behaviors include one or more of panning displayed results on the computing device and the speed of panning displayed results on the computing device.

16. The computer-readable medium of claim 12, wherein the monitored evaluation behaviors include utilizing zoom features of the computing device to expand data of the displayed results.

17. The computer-readable medium of claim 12, wherein the monitored evaluation behaviors include swiping results from the screen and the speed of panning displayed results on the computing device.

18. A computing system for evaluating the evaluation behaviors of an evaluator, the computing system comprising a processor and a memory, wherein the processor executes instructions stored in the memory as part of or in conjunction with additional executable components to evaluate the evaluation behaviors of an evaluator, the additional executable components comprising:
an evaluation request module that, in execution, causes the processor to submit an evaluation request to a response service and, in response, obtain results from the response service corresponding to the evaluation request; and
an evaluation module that, in execution, causes the processor to:
monitor evaluation behaviors of the evaluator with regard to the obtained results, wherein the monitored evaluation behaviors include one or more non-click evaluation behaviors;
storing the monitored evaluation behaviors in association with an evaluation of the obtained results by the evaluator;
applying one or more heuristics or rules to the monitored evaluation behaviors to determining whether the monitored evaluation behaviors are within predetermined quality thresholds; and
flagging the monitored evaluation behaviors as anomalous evaluation behaviors if the monitored evaluation behaviors are not within the predetermined quality thresholds.

19. The computing system of claim 18, wherein:
the evaluation request module further causes the processor to submit a plurality of evaluation requests to the response service and, in response, obtain results from the response service corresponding to the plurality of evaluation requests; and
the evaluation module further causes the processor to:
monitor the evaluation behaviors of the evaluator in regard to the obtain results for each of the plurality of evaluation requests
store a plurality of evaluation records, each of the plurality of evaluation records comprising monitored evaluation behaviors of the evaluator with regard to an evaluation record of the plurality of evaluation records, and a corresponding evaluation of the obtained results with regard to the evaluation record of the plurality of evaluation records; and
for each of the plurality of evaluation records:
apply one or more heuristics or rules to the corresponding monitored evaluation behaviors to determining whether the corresponding monitored evaluation behaviors are within predetermined quality thresholds; and
flag the evaluation record as anomalous if the corresponding monitored evaluation behaviors are not within the predetermined quality thresholds.

20. The computing system of claim 19, wherein the evaluation module further causes the processor to:
determine whether the number of evaluation records flagged as anomalous exceed predetermined thresholds; and
execute an action with regard to the evaluator if the number of evaluation records flagged as anomalous exceeds the predetermined thresholds.
